(19) United States
(12) Patent Application Publication
(10) Pub. No.: US 2017/0220759 A1
(43) Pub. Date: Aug. 3, 2017

(54) SYSTEM AND METHOD FOR MONITORING AND PROMOTION OF BEHAVIORS WHICH IMPACT HEALTH CARE COSTS

(71) Applicant: James V. Campbell, Gaithersburg, MD (US)

(72) Inventor: James V. Campbell, Gaithersburg, MD (US)

(21) Appl. No.: 15/435,358

(22) Filed: Feb. 17, 2017

Related U.S. Application Data
(63) Continuation of application No. 14/510,674, filed on Oct. 9, 2014, now abandoned.
(60) Provisional application No. 61/888,771, filed on Oct. 9, 2013.

(51) Int. Cl. G06F 19/00

(52) U.S. Cl. CPC G06F 19/3418; G06F 19/328; G06F 19/3431; G06Q 30/0206

(57) ABSTRACT

A health-monitoring system is disclosed. The system includes data acquisition for acquiring health-related information from a plurality of individuals and analysis of the health-related information to make predictions about future health care costs of the individuals.

### CROSS-REFERENCE TO RELATED APPLICATIONS

The present application is a continuation of U.S. patent application Ser. No. 14/510,674, filed Oct. 9, 2014, which claims the benefit of U.S. Provisional Patent Application No. 61/888,771, filed Oct. 9, 2013. The foregoing disclosures are expressly incorporated by reference herein in their entirety.

### FIELD OF THE INVENTION

The present disclosure relates a system and method for the monitoring and/or promotion of behaviors which impact health care costs and, specifically, to algorithmic processes created to predict future health care costs based on both individual and group behaviors within organizations.

### BACKGROUND OF THE INVENTION

Organizations pay insurance premiums based on assumptions and predictions of future costs derived from national and regional actuarial data. This data, however, may or may not be truly predictive of the future health care costs for a particular organization, because there is a direct causal relationship between the health-related behaviors of individuals within the organization and the amount of health care they and their families will require in the future.

While this causality is known, there is currently no means by which an organization can access, monitor, and collect data concerning the health-related behaviors of individual employees in order to accurately predict their future health care costs.

In response to this lack, organizations have increasingly used “Wellness” programs in an attempt to influence the health-related behaviors of individuals within their organizations, with the goal of reducing health care costs for the individual and payouts for their insurers.

Wellness programs are incomplete and inadequate in reducing health care costs and payouts because they (1) fail to monitor the broad range of individual behaviors which directly impact health care costs, (2) fail to track and mathematically quantify behavioral changes of individuals and groups within the organization and (3) fail to provide statistical data of the size and scope required to make predictable statements about future costs which might then be used to negotiate lower insurance rates.

### SUMMARY OF THE INVENTION

Disclosed is a system and method for monitoring and/or promotion of behaviors which impact health care costs. In any number of embodiments, the system can include a data acquisition means for acquiring health-related information from individuals and an analysis means for analyzing the acquired health-related information to make predictions about the individuals' future health care costs. The data acquisition means can include fitness-device means for collecting data regarding health-related activities such as, e.g., a number of steps taken, from personal fitness devices and direct user-input means for allowing individuals to record additional data regarding their health-related activities. The direct user-input means can include a website. The fitness-device means can include a mobile application configured to interface with individuals' personal fitness devices. The analysis means can be configured to calculate a wellness score for each individual. The analysis means can be configured to compare collected data regarding health-related activities to external statistical data, such as, e.g., BRFSS data (as defined below).

In any number of embodiments, the analysis means can be configured to combine intake data for demographics and pre-existing conditions, real-time health behavior data, and actual utilization cost to calculate predictive health care utilization costs.

### BRIEF DESCRIPTION OF THE DRAWINGS

FIG. 1 is a diagram of a system architecture according to one embodiment of the present invention.

FIG. 2 is a diagram of a mobile application development architecture according to one embodiment of the present invention.

FIGS. 3a and 3b is a workflow diagram of a user signup process according to one embodiment of the present invention.

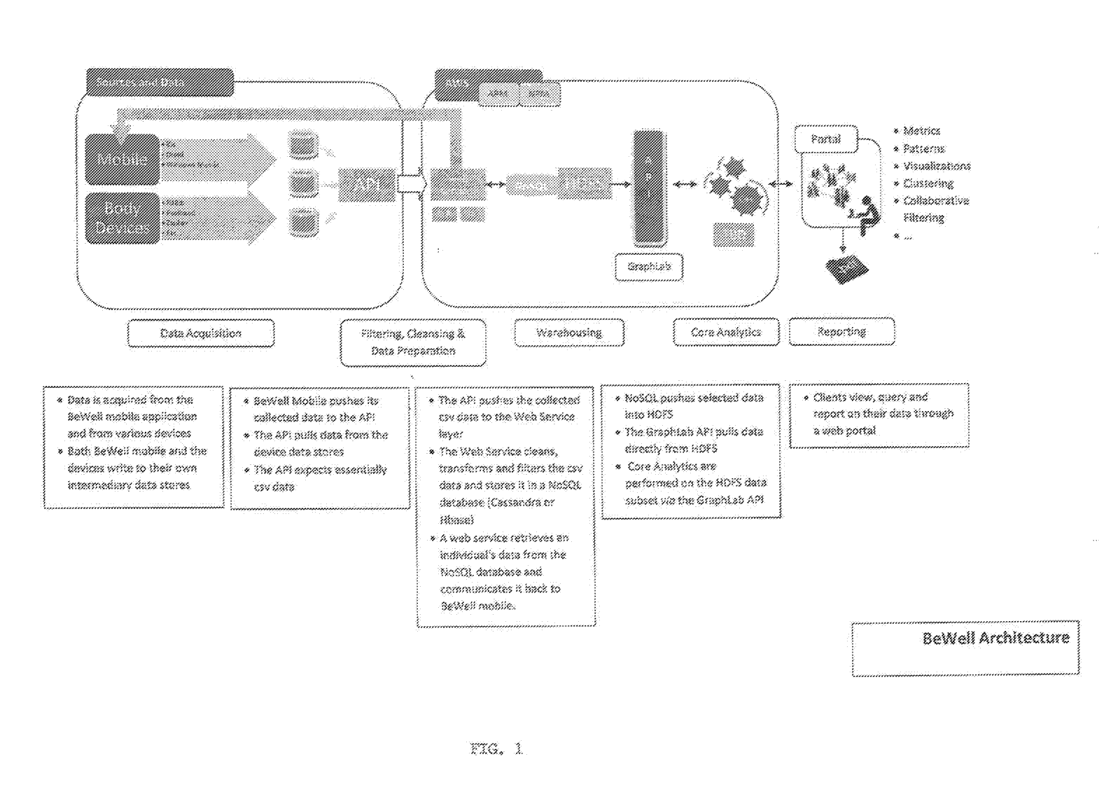

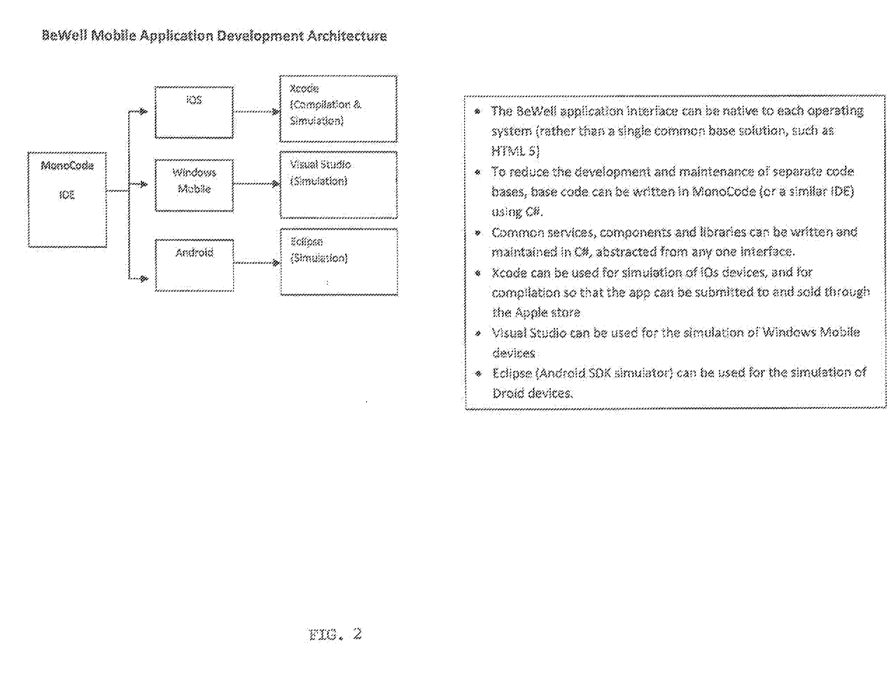

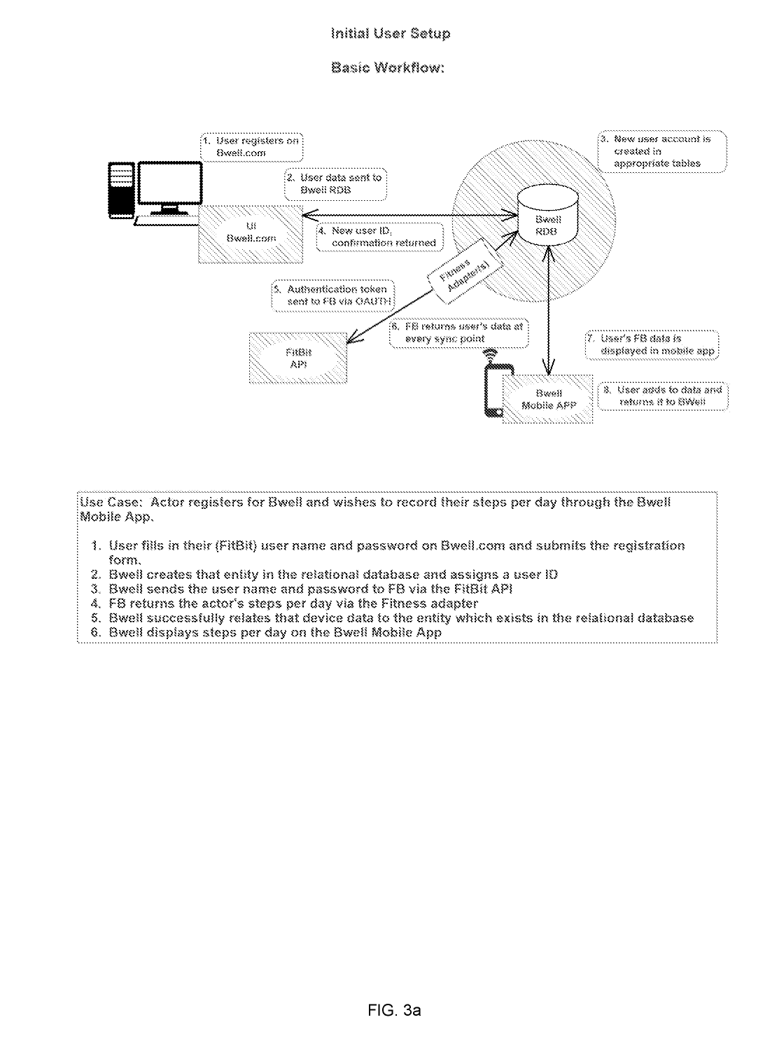

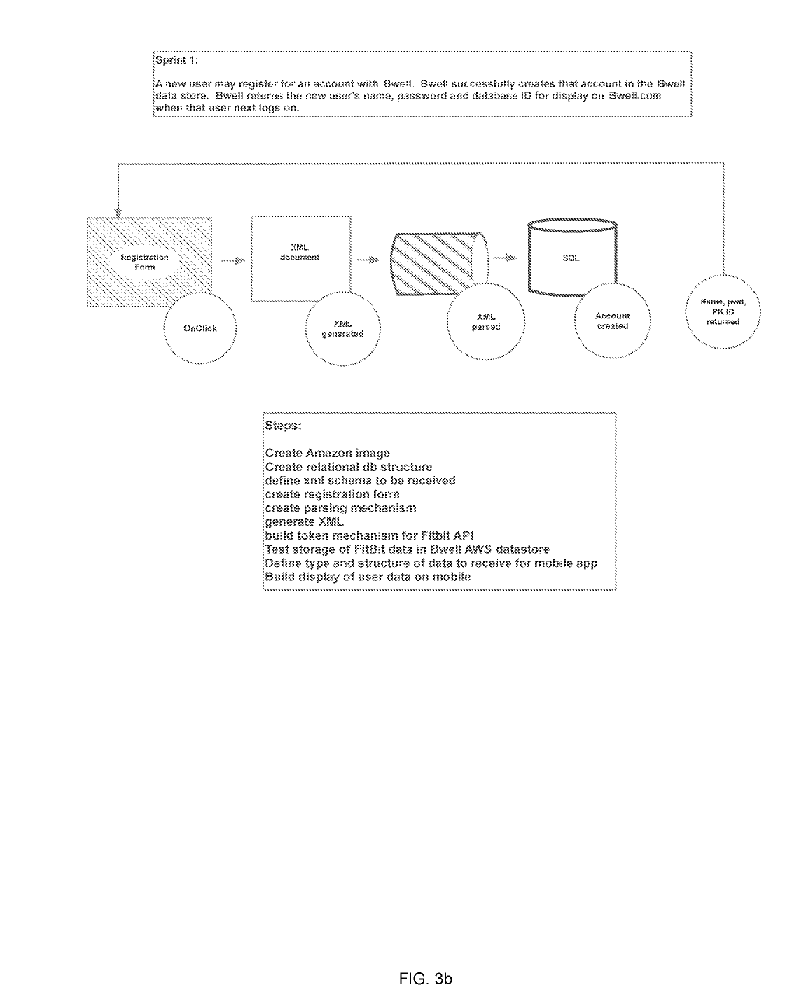

### DETAILED DESCRIPTION

Input Layer. A health monitoring and promotion system and method (sometimes referred to as “BWell” in the present disclosure) can utilize the popularity of and metrics collected by personal fitness devices, such as FitBit, Jawbone, and Nike Fuelband to gather hourly data about the activities of employees. Using APIs to communicate with the third party fitness-device vendor servers, servers associated with the health and monitoring and promotion system can uptake employee data each time the employees synch their devices.

This data can then be used to populate two interfaces: (1) a health monitoring and promotion mobile application, which employees can install on their mobile devices, and (2) a website associated with the health monitoring and promotion system. Users will be able to add additional information regarding their health-related activities, and will also be kept up to date at all times regarding their progress against set health targets. For example, a user who is overweight may set a target weight to maximize their health. This change in behaviors has a known causal relationship to the likelihood of payouts for the claims of that individual. The system can then chart their progress against their goal and will seek to encourage further progress through gameification, reminders and positive reinforcement. Users can also, via either interface, record additional information about their activities, even if those activities are not recorded by their fitness devices.

The user information thus gathered from a combination of direct user-input and data collected from fitness-device APIs can be stored in an appropriate environment. As an example, in any number of embodiments, an Amazon Elastic MapReduce (Amazon EMR) environment can be used, based on a hosted Hadoop framework running on Amazon Elastic Compute Cloud (Amazon EC2) and Amazon Simple Storage Service (Amazon S3).

Analysis. Within the EMR environment, health monitoring algorithms can be used to compare the behavior of individuals using the system against information collected from a suitable source, such as, e.g., the Centers for Disease Control (CDC). The CDC provides detailed statistics regarding typical exercise and health activities of Americans, broken down demographically. In any number of embodiments, the health monitoring algorithm can be written in C# or other suitable programming language and hosted in the Microsoft .NET framework.

Initially, certain assumptions will be made of necessity, for example that the average health activities of individuals within a certain demographic lead to the average payouts for individuals within that demographic. The health monitoring and promotion system can then rationally anticipate payout reductions for individuals within that demographic who consistently surpass national averages. As the system continues to harvest data from end users, these assumptions can be validated by the actual payouts for those individuals over time, and the system itself will become a quantifiable means of projecting health care costs based on behavior. This capability—to directly relate behaviors to payouts and to then quantify projections of future costs—provides a significant advantage when compared to prior services.

Reporting. The projections generated by the health monitoring and promotion system can be made available to organizations whose members utilize the disclosures through custom reports. The reports can be generated using the aforementioned algorithms written in C#, and can be generated using, e.g., the JScharts reporting environment. The reports can include increasing levels of bioinformatics analysis as the amount of data gathered from users increases, and as the disclosure correlates behavioral changes to changes in annual payouts over time.

Initially, the reports can include the following: “wellness progression scale”; “Employee Social Interaction Scale”; and a “Predictive Savings Report.” Each of these will be described in more detail below.

Wellness progression scale—Employee Wellness High/Perform-Low Performer. Wellness progression of employees can be presented as percentiles. The percentile rank can be calculated as p=B+0.5E/ N where B is the number of scores below the user's wellness score (S) E is the number of scores equal to S, and Nis the total number of users. Initially S can be set equal to the user's average daily step count or minutes of activity (with 10,000 steps considered equivalent to 30 minutes of activity). However, as data is collected and the key indicators of wellness are identified, S will be adjusted. The adjusted S will potentially measure activity levels (steps or minutes), sleep, caloric intake, BMI, or other appropriate health-related variables.

Employee Social Interaction Scale—Employers Wellness Performance vs. Nation (leveraging longitudinal study and CDC data); leaders may be tracked in a “Trailblazer” report. The Centers for Disease Control and Prevention (CDC) Behavior Risk Factor Surveillance System (BRFSS) provides a survey data of the US tracking health behaviors. The BRFSS data can be used to create a national baseline to be used as a comparison against a company's health behavior profiles. A demographic profile including such variables as age, educational level, employment, income, geographic location, and gender can be used to filter the BRFSS data to create the comparison baseline.

The CDC BRFSS tracks respondents' physical activity in minutes of activity per week with the calculated variable PAMIN_. The physical activity of BWell can be collected daily in terms of number of steps taken. A daily total of 10,000 steps is roughly equivalent to the Surgeon General's recommendation of 30 minutes of activity. The variables can be made comparable by converting the CDC BRFSS data from average weekly minutes of activity into daily step count. The comparison can be between the calculated daily activity means for BRFSS respondents and the calculated daily activity mean for the BWell users of the profiled company.

As the key cost drivers are identified to enhance the Wellness Progression Scale by developing a BWell Wellness Score (S), the Employee Social Interaction Scale report can also be updated to use the BWell Wellness Score.

BRFSS conversion: average daily step count=((PAMIN_/7)/30)*10000.

Predictive Savings Report—Employers Predictive Health Care Cost. The predicting savings report can combine intake data for demographics and pre-existing conditions, real-time health behavior data, and actual utilization costs to calculate predictive utilization costs as users' health behaviors change over time. The baseline calculation can be performed through the use of a multivariate linear regression tool. This model can be used to establish a performance baseline for the BWell engine and demonstrate the generation of the Predictive Savings Report while more optimal models are calculated.

Linear Regression Model

yᵢ=β₁x₁+β₂x₂+β₃x₃+ . . . +βᵢx₁+εᵢ

Error Term: ε=y−ŷ

### Regression Equation:

ŷ=b₁x₁+b₂x₂+b₃x₃+ . . . +bᵢxᵢ

### Adjusted R²:

### Definition of Data:

y: utilization cost in dollars
x₁: activity data (step count of minutes of activity)
x₂: sleep data (minutes of sleep)
x₃: age (in years)
x₄: gender
x₅: height (in inches)
x₆: weight (in pounds)
Or alternatively:
x₅: BMI: calculated

$$BMI = \frac{weight}{{( height )}^{2}} \times 703$$

As the BWell application matures, more data can be collected and incorporated into the model to better predict utilization costs.

Best fit. As data collection progresses multivariate linear regression may not be the best method for predicting utilization costs. More sophisticated regression models are available and can be continually evaluated against the linear regression model baseline calculation. Evaluation criteria can include fitting the shape of the plotted data, minimizing the margin of error, and speed of calculation.

What is claimed is:

1. A health-monitoring system comprising:
data acquisition means for acquiring health-related information from a plurality of individuals; and
analysis means for analyzing said health-related information to make predictions about future health care costs of said plurality of individuals.

2. The health-monitoring system of claim 1, wherein said data acquisition means:
fitness-device means for collecting data regarding health-related activities from a plurality of personal fitness devices associated with said plurality of individuals; and
direct user-input means for allowing said plurality of individuals to record additional data regarding health-related activities.

3. The health-monitoring system of claim 2, wherein said direct user-input means comprises a website.

4. The health-monitoring system of claim 2, wherein said fitness-device means comprises a mobile application configured to interface with said plurality of personal fitness devices.

5. The health-monitoring system of claim 2, wherein said fitness-device means is configured to collect data regarding a number of steps taken.

6. The health-monitoring system of claim 1, wherein said analysis means is configured to calculate a wellness score for each of said plurality of individuals.

7. The health-monitoring system of claim 1, wherein said analysis means is configured to compare said data regarding health-related activities to external statistical data.

8. The health-monitoring system of claim 7, wherein said external statistical data comprises Behavior Risk Factor Surveillance System data.

9. The health-monitoring system of claim 1, wherein said analysis means is configured to combine intake data for demographics and pre-existing conditions, real-time health behavior data, and actual utilization costs to calculate predictive health care utilization costs.

10. The health-monitoring system of claim 1, wherein said analysis means is configured to utilize multivariate linear regression to calculate said predictive health care utilization costs.
